(19) United States
(12) Patent Application Publication
(10) Pub. No.: US 2002/0079801 A1
(43) Pub. Date: Jun. 27, 2002

(54) Spark plug having a central electrode which is welded or soldered on and method for its production

(76) Inventors: Dittmar Klett, Pleidelsheim (DE); Simon Schmittinger, Renningen (DE); Dietrich Trachte, Leonberg (DE); Walter Benedikt, Kornwestheim (DE)

Correspondence Address: KENYON & KENYON, ONE BROADWAY, NEW YORK, NY, 10004, US

(21) Appl. No.: 09/964,829

(22) Filed: Sep. 26, 2001

(30) Foreign Application Priority Data
Sep. 26, 2000 (DE) 100 47 499.3

(51) Int. Cl. H01T 13/20

(52) U.S. Cl. 313/143

(57) ABSTRACT

A spark plug includes a partially cylindrical insulator element, including a bore hole and a central electrode located in an opening in the base part of the insulator element. The insulator element and the central electrode are connected by at least one metallic soldered connection and/or one metallic welded connection and/or one friction-locked connection aligned in the radial direction.

### FIELD OF THE INVENTION

The present invention relates to a spark plug which includes a partially cylindrical insulator element having a bore hole. A central electrode is located in the bore hole of the insulator element on the side of a base part of the insulator element (referred to hereinafter in short as base part). The present invention also relates to a corresponding method for production of the spark plug.

### BACKGROUND INFORMATION

In conventional spark plugs, the central electrode is, for example, cast into the insulator element with the aid of a glass melt and/or with the aid of a contact or compound. The glass melt simultaneously acts as a damping resistor to damp the spark discharge during operation of the spark plug.

It is an object of the present invention to provide a compact spark plug and a corresponding method for its production, with the metal electrode being attachable in the insulator element in a simple manner.

### SUMMARY

The above and other beneficial objects of the present invention are achieved by providing a spark plug and a method for its production as described herein.

The present invention is based on the concept that a glass melt and/or an adhesive, contact or compound are only suitable for attachment of the metal electrode on or in the insulator element under certain conditions. Therefore, in the spark plug according to the present invention, the insulator element and central electrode are connected by at least one metallic soldered connection or one metallic welded connection. The soldered connection may be produced by hard soldering or active soldering, i.e., through a soldering procedure at a temperature over 450° C. The soldered connection may be produced through fusion welding, friction welding, or, for example, inductive welding.

In one example embodiment of the present invention, the connection is at an end of the central electrode further from the combustion chamber. The outer diameter of the central electrode is slightly smaller in the region of the connection than the inner diameter of the insulator element at the same distance from the free end of the base part. The connection extends along the circumference of the central electrode and closes the gap between the central electrode and the insulator element. In this manner, the connection performs a double function—it connects and seals gas-tight.

In an alternative example embodiment of the present invention, the inner diameter of the insulator element in the region of the connection is slightly smaller than the outer diameter of the central electrode, not including the surrounding insulator core, at the same distance from the free end of the base part. In the assembled state, the central electrode is pressed together by a surrounding insulator core. A very solid connection is produced due to the differing coefficients of thermal expansion.

To produce the friction-locked connection, the metallic central electrode is, for example, cooled down and inserted in its contracted state into the insulator element. As it warms up, the central electrode expands and is pressed against the inner wall of the insulator element.

In a further example embodiment of the spark plug according to the present invention, a force is exerted on the central electrode in the axial direction with the aid of a spring-loaded element, for example, with the aid of a contact pin. The force exerted by the contact pin counteracts forces which arise in the combustion chamber during operation of the spark plug and are transmitted to the central electrode. The connection between the central electrode and the insulator element is stressed less by the use of the contact pin than if the contact pin is not there. In this manner, the connection between the central electrode and the insulator element may be configured smaller or may be stressed more while remaining the same size.

In a further example embodiment of the present invention, the contact pin is buckled at at least one position. The spring effect may be increased by buckling the contact pin. Excess mechanical stress is prevented in the insulator element when a terminal stud is being screwed in if the contact pin buckles when specific stresses are exceeded.

In the spark plug according to the present invention, the insulator element includes ceramic. The surface of the ceramic is treated in the region of the connection so that the load capacity of the connection is enhanced. Roughening of the surface and/or applying a metallic topcoat may be suitable methods.

### BRIEF DESCRIPTION OF THE DRAWINGS

FIGS. 1A and 1B illustrate a compact spark plug with a damping resistor made of a solidified glass melt.

FIGS. 2A and 2B illustrate a compact spark plug without a damping resistor.

FIGS. 3A and 3B illustrate a compact spark plug with a nondestructively replaceable damping resistor.

### DETAILED DESCRIPTION

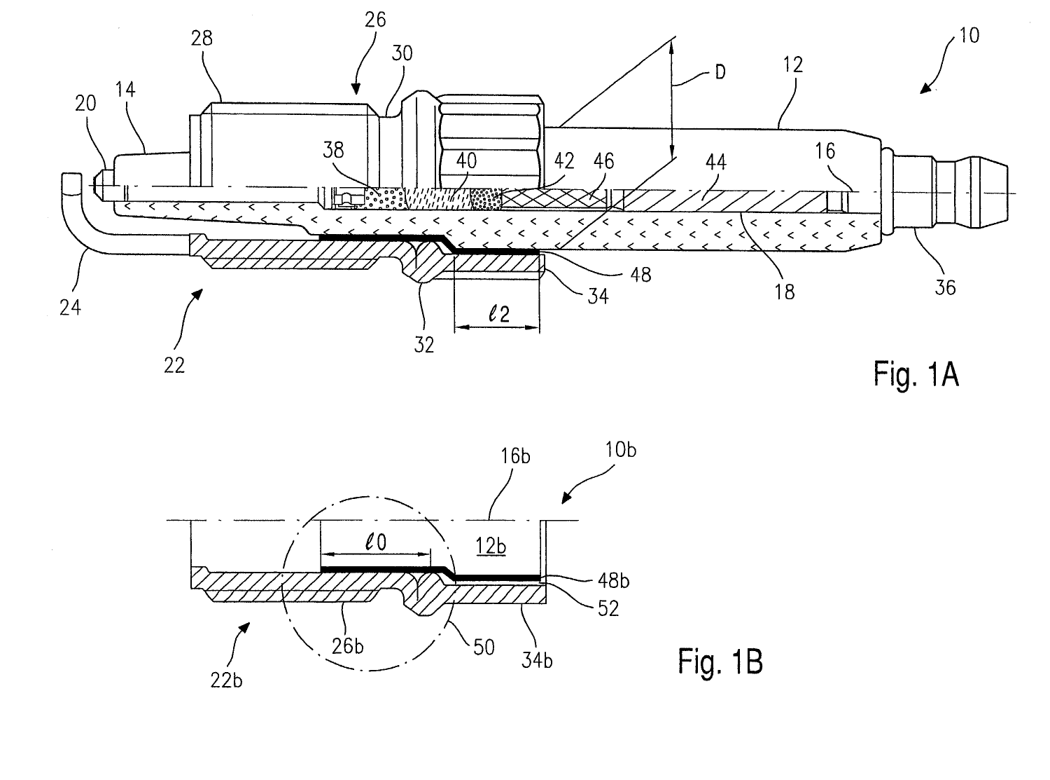

FIG. 1A illustrates a compact spark plug 10 in a partial cross-sectional view. Spark plug 10 includes a cylindrical insulator 12 which tapers at its end toward an insulator base 14. Insulator 12 is penetrated along its longitudinal axis 16 by a through hole 18, the diameter in the region of a central electrode 20 of which is somewhat smaller than along the rest of insulator 12. The half of insulator 12 containing insulator base 14 is almost completely surrounded by a housing 22. Viewed from insulator base 14 outwardly, housing 22 includes, in this sequence, a ground electrode 24, a threaded sleeve 26 having, for example, M14 external thread 28, a peripheral groove 30 for a sealing ring which provides a seal in the conical seal seat, a central part 32, and a double hex insertion nut 34. Housing 22 is screwed into an engine block of the vehicle and is connected with the ground electrode. Insulator 12, which is made of ceramic, insulates housing 22 and central electrode 20 as well as additional elements for current conduction located in through hole 18.

In through hole 18 there are, in sequence from central electrode 20 to a terminal stud 36 screwed onto insulator 12 for connection of an ignition cable, an electrically conducting contact or compound 38, a glass melt 40, which forms a damping resistor, an electrically conducting contact or compound 42, and an electrode 44. Electrode 44 tapers toward insulator base 14 and forms a section 46 having a somewhat smaller diameter than the main part of electrode 44.

Housing 22 is connected to insulator 10 by a welded connection 48. Welded connection 48 extends longitudinally up into threaded sleeve 26 from the end of housing 22 further from the base part. Welded connection 48 extends completely around the circumference arranged transverse to the longitudinal direction. A gap between insertion nut 34 and insulator 12 is completely closed by welded connection 48. A gap formed between the end of threaded sleeve 26 further from the base part and insulator 10 is also completely closed by welded connection 48.

FIG. 1B illustrates a connection 48b, in which a housing 22b, constructed like housing 22, of a spark plug 10b having an insulator 12b is only welded in a region 50 which extends along the half of a threaded sleeve 26b further from the base part. Region 50 extends, for example, 10=10 mm in the longitudinal direction, i.e., in the direction of a longitudinal axis 16b of insulator 12b. Welded connection 48b extends along the lateral surface of insulator 12b in region 50.

In the region of a insertion nut 34b constructed like insertion nut 34, a peripheral gap 52 is disposed between insulator 12b and insertion nut 34b. Otherwise, spark plug 10b is constructed like spark plug 10.

Due to welded connection 48 or 48b, spark plug 10 may be made very compact. The largest diameter D of insulator 12 is, for example, 10.4 mm. Diameter D remains constant in the main part of insulator 12 and therefore substantially determines the overall space necessary for the installation of spark plug 10. Insertion nut 34 is configured as a double hex nut, e.g., for a width 14 across flats. This is only possible because insulator 12 has no projections in the region of insertion nut 34.

In other example embodiments of the present invention, an interlayer may be used, in place of welded connection 48 or 48b, which is welded or soldered onto insulator 12 or 12b and onto housing 22 or 22b. The welded or soldered connections, respectively, between the interlayer and insulator 12 and between the interlayer and housing 22 are in the region of central part 32 and threaded sleeve 26 and in the region of insertion nut 34. Alternatively, there are connections between the interlayer and insulator 12b both in the region of threaded sleeve 26b and in the region of insertion nut 34b. In the alternative, a connection exists between the interlayer and housing 22b only in the region of threaded sleeve 26b. A gap is disposed between the interlayer and insertion nut 34b in the region of insertion nut 34b.

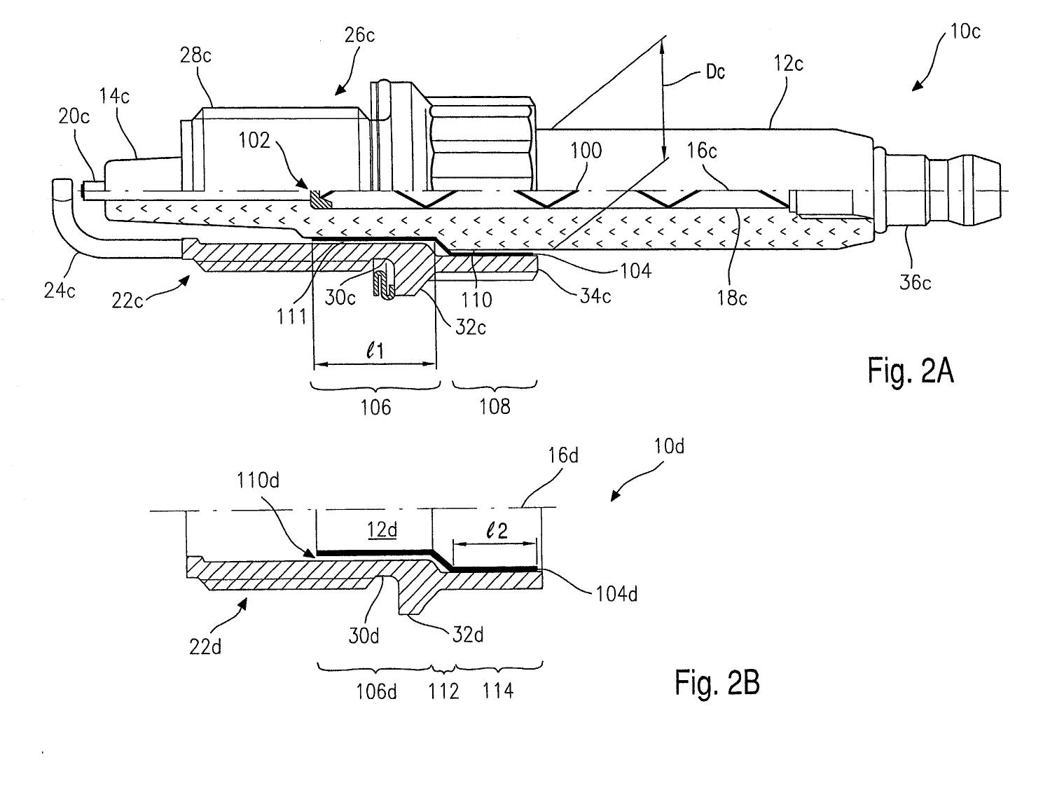

FIG. 2A illustrates, in a partial cross-sectional view, a compact spark plug 10c which has no damping resistor. Functional elements illustrated in FIG. 2A which are constructed substantially like those described with reference to FIG. 1A have the same reference numbers in FIG. 2A but are suffixed with the lowercase letter c. This particularly applies to reference numbers 12c to 36c. Central electrode 20c has a diameter in its main part which is smaller than the diameter of central electrode 20. This arrangement allows the diameter of through hole 18c and outer diameter Dc of insulator 10c to be reduced. Central electrode 20c is coated with a hard solder paste and then inserted through through hole 18c into insulator 12c. A contact pin 100, made of, for example, a brass alloy, is inserted into through hole 18c. When terminal stud 36c is screwed in, contact pin 100 is compressed and buckles at multiple buckling positions.

Central electrode 20c is secured by contact pin 100. Insulator 10 is transported through a high vacuum furnace at a temperature of a magnitude between 600° C. and 900° C., for example, 800° C. The hard solder paste melts and connects central electrode 20c firmly and permanently with insulator 12c. This connection is also gas-tight. The hard solder paste is, for example, applied in the region of a shoulder 102, at which the inner diameter of through hole 18c decreases. Alternatively, central electrode 20c may be coated substantially completely with hard solder paste, so that central electrode 20c and insulator 10c are also connected in the region of insulator base 14c.

There is an interlayer 104 on insulator 10c which is less than, for example, 1 mm thick. Interlayer 104 is connected to insulator 10c via, for example, a hard soldered connection, in the region of a step 106 of insulator 10c, which is approximately, e.g., 11=12 mm long. At the end of step 106 further from the base part, interlayer 104 conforms to the shape of insulator 10c, which widens. In a section 108, however, interlayer 104 forms a tubular section having a larger inner diameter than outer diameter Dc of insulator 10c. Thus, there is a gap 110 in the region of section 108 between interlayer 104 and insulator 10c. In section 108, interlayer 104 is connected on its outer side with the inner side of insertion nut 34c, for example, by a soldered or welded connection. In the region of step 106, the outer side of interlayer 104 is not connected with housing 22c, so that in this region a gap 111 is disposed between interlayer 104 and housing 22c.

Through the shaping and nature of the attachment of interlayer 104, forces which arise in housing 22c as spark plug 10c is screwed in may not be transmitted directly to insulator 10c. Interlayer 104 absorbs these forces in the transition region between step 106 and section 108.

FIG. 2B illustrates a spark plug 10d constructed similarly to spark plug 10c. There are differences only in the region of an interlayer 104d, which is used in place of interlayer 104. Interlayer 104d is connected in the region of a step 106d with an insulator 12d. In a transition region 112, interlayer 104d widens conically in correspondence with the shape of insulator 12d. In transition region 112, as well as in an adjacent section 114, the inner side of interlayer 104d is also connected with insulator 12d, for example, with the aid of a soldered or welded connection.

The outer side of interlayer 104d is exposed in the region of step 106d, so that a gap 110d is formed between interlayer 104d and housing 22d. The outer side of interlayer 104d is connected to housing 22d in the region of section 114, for example, by soldering or welding. The connection has a length of, e.g., 12=8 mm along a longitudinal axis 16d.

Mechanical stresses which arise in the region of a groove 30d as spark plug 10d is screwed in may not be directly transmitted to insulator 12d due to gap 110d. The force lines first extend into housing 22d and only enter insulator core 12d in section 114. The forces are, however, less at this point than in the region of groove 30d.

A sealing ring is located in the region of groove 30d which forms a seal in the flat sealing seat between the engine block and a central part 32d. Otherwise, spark plug 10d is constructed like spark plug 10c.

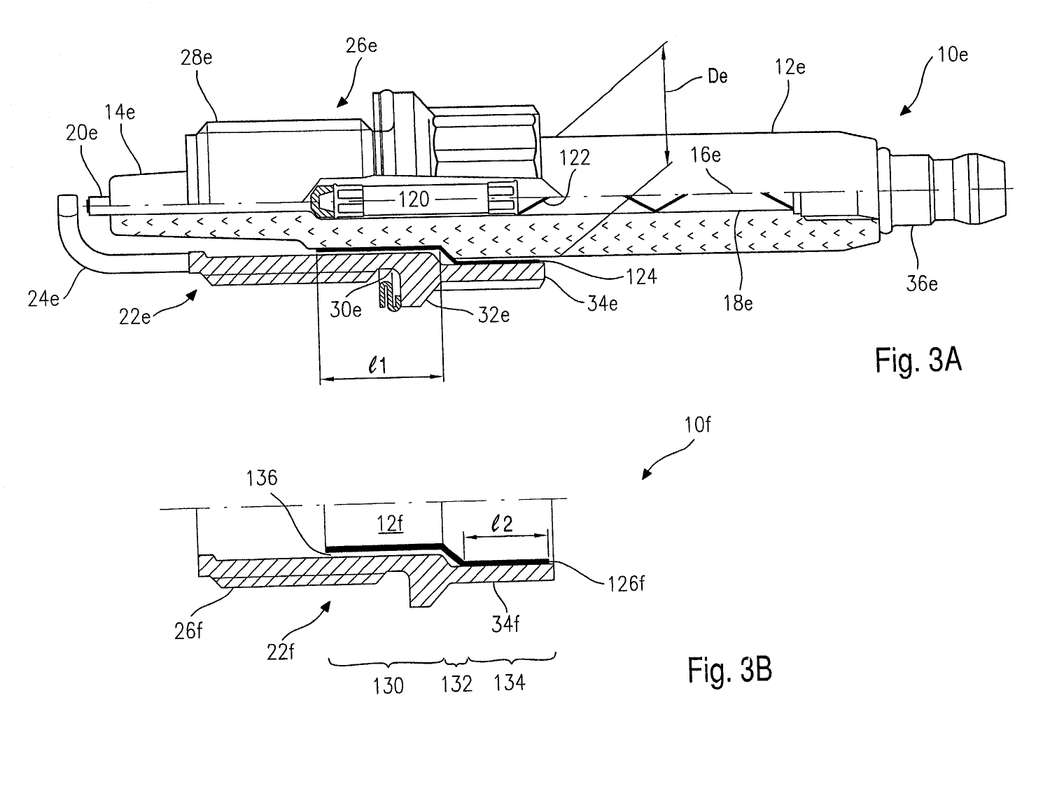

FIG. 3A is a partial cross-sectional view of a compact spark plug 10e which is constructed similarly to spark plug 10c illustrated in FIG. 2A. Elements with reference numbers 12e to 36e correspond in their configuration and function to the elements 12c to 36c explained above with reference to FIG. 2A.

Central electrode 20e is inserted first into through hole 18e. Subsequently, a replaceable damping resistor 120 is inserted, which has a shape resembling a conventional fuse. Only then is a contact pin 122 inserted, which buckles at multiple buckling positions as terminal stud 36e is screwed in. Insulator 12e, which was screwed on in this manner, is in turn heated to approximately 800° C., with a soldering paste applied to central electrode 20e melting and central electrode 20e connecting with insulator 12e.

An interlayer 124 corresponds to interlayer 104 in its configuration, function, and type of attachment to insulator 12e and housing 22e describe above with reference to FIG. 2A.

FIG. 3B illustrates a part of a spark plug 10f, which is configured like spark plug 10e as described above with reference to FIG. 3A. An interlayer 126f is soldered onto insulator 12f of spark plug 10f in a section 130. Section 130 is arranged within threaded sleeve 26f. The inner diameter of interlayer 126f and the diameter of insulator 12f increase uniformly within a transition section 132. In the region of a section 134 arranged within insertion nut 34f, the inner diameter of the sleeve formed by interlayer 126f remains constant. The diameter of insulator 12f also remains constant within section 134. In section 134, interlayer 126f is soldered to both insulator 12f and housing 22f. In contrast, in the region of section 130 and in the region of transition section 132, a gap 136 is disposed between housing 22f and insulator 12f.

What is claimed is:

1. A spark plug, comprising:
a partially cylindrical insulating element having a bore hole and a base part; and
a central electrode located in an opening in the base part of the insulating element;
wherein the insulating element and the central electrode are connected by at least one of an at least one metallic soldered connection and a metallic welded connection.

2. The spark plug according to claim 1, wherein the connection is located at an end of the central electrode further from the base part, an outer diameter of the central electrode being slightly smaller in a region of the connection than an inner diameter of the insulating element disposed at the same distance from a free end of the base part, the connection closing a gap between the central electrode and the insulating element substantially along a circumference of the central electrode.

3. The spark plug according to claim 1, wherein an inner diameter of the insulating element is slightly smaller than an outer diameter of the central electrode, not including a surrounding insulator core, at the same distance from a free end of the base part.

4. The spark plug according to claim 3, wherein a friction-locked connection is produced by an installation of the central electrode into the insulating element, the insulating element having a higher temperature than the central electrode at a time of the installation.

5. The spark plug according to claim 1, wherein a force is exerted on the central electrode in an axial direction in accordance with a spring-loaded element.

6. The spark plug according to claim 5, wherein the spring-loaded element includes a contact pin.

7. The spark plug according to claim 6, wherein the contact pin is buckled at least once.

8. The spark plug according to claim 1, wherein the insulating element includes ceramic and wherein a surface of the ceramic is treated in a region of the connection so that a load capacity of the connection is elevated.

9. A method for producing a spark plug including a partially cylindrical insulating element having a bore hole and a base part and a central electrode located in an opening in the base part of the insulating element, the insulating element and the central electrode being connected by at least one of an at least one metallic soldered connection and a metallic welded connection, comprising the steps of:
providing one of the central electrode and an inside of the insulating element with one of a metallic soldering material and a metallic welding material;
inserting the central electrode into the insulating element; and
melting the one of the metallic soldering material and the metallic welding material.

10. The method according to claim 9, wherein the one of the metallic soldering material and the metallic welding material is provided in the providing step so that the connection substantially closes a gap between the central electrode and the insulating element along a circumference of the central electrode.

11. The method according to claim 9, wherein the inserting step includes the substep of producing a friction-locked connection with the insulating element having a higher temperature than the central electrode at a time of the inserting.

12. The method according to claim 9, wherein the insulating element includes ceramic, the method further comprising the step of treating a surface of the ceramic in a region of the connection so that a load capacity of the connection is elevated.
